(19) United States
(12) Patent Application Publication
(10) Pub. No.: US 2026/0121353 A1
(43) Pub. Date: Apr. 30, 2026

(54) CONNECTOR

(71) Applicant: DONGGUAN LEADER PRECISION INDUSTRY CO., LTD., Dongguan City (CN)

(72) Inventors: Bin ZHANG, Dongguan City (CN); Zhengguo SUN, Dongguan City (CN); Jiamei WAN, Dongguan City (CN); Bo WANG, Dongguan City (CN); Jianshe HU, Dongguan City (CN)

(73) Assignee: DONGGUAN LEADER PRECISION INDUSTRY CO., LTD., Dongguan City (CN)

(21) Appl. No.: 19/368,254

(22) Filed: Oct. 24, 2025

(30) Foreign Application Priority Data
Oct. 25, 2024 (CN) 202411505039.9

(51) Int. Cl. H01R 13/6581; H01R 13/424; H01R 13/506

(52) U.S. Cl. CPC H01R 13/6581; H01R 13/424; H01R 13/506

(57) ABSTRACT

Disclosed is a connector including an insulating seat and a shielding shell. The insulating seat includes a first end and a second end, the first end and the second end are opposite in a first direction, the first end of the insulating seat is connected to an external plug, the first end of the insulating seat is provided with a boss, the boss is provided with a first opening, the first opening is used to connect the external plug, the insulating seat is provided with a second opening, the second opening is arranged on a side of the boss, and the side faces the second end of the insulating seat. The shielding shell has a first side, and an elastic sheet is provided on the first side of the shielding shell.

### CROSS-REFERENCE TO RELATED APPLICATIONS

The present application claims priority of Chinese Patent Application No. 202411505039.9, filed on Oct. 25, 2024 before the China National Intellectual Property Administration of the People's Republic of China and titled “CONNECTOR”, the entire content of which is incorporated herein by reference.

### FIELD

The present application relates to the technical field of connectors, in particular to a connector.

### BACKGROUND

As the functions of electronic products are increasingly rich, the requirements for connection stability and shielding performance of connector products are increasingly high. In the prior art, a connector usually includes an insulating body, a conductive terminal, and a shielding shell.

Currently, the common design of the connector is to insert the conductive terminal into the insulating body and then assemble the shielding shell from a rear end to a front end of the insulating body. After an external plug is connected to the connector, due to excessive insertion during connection or external force after connection, the end of the shielding shell near the external plug is squeezed and bent outward, resulting in poor connection stability of the shielding shell, degradation in the shielding performance of the connector, and possible invasion of external interference signals into the connector, thereby affecting the normal operation of an electrical appliance.

### SUMMARY

An embodiment of the present application provides a connector, including: an insulating seat including a first end and a second end, wherein the first end and the second end are opposite in a first direction, the first end of the insulating seat is connected to an external plug, the first end of the insulating seat is provided with a boss, the boss is provided with a first opening, the first opening is used to connect the external plug, and the insulating seat is provided with a second opening; and a shielding shell, wherein the shielding shell has a first side, and an elastic sheet is provided on the first side of the shielding shell; wherein when the shielding shell is sleeved on a peripheral side of the insulating seat along a second direction, the elastic sheet is connected to the second opening, and the first side of the shielding shell abuts against the boss, the second direction intersecting with the first direction.

### BRIEF DESCRIPTION OF THE DRAWINGS

FIG. 1 is a schematic structural diagram of a connector provided in one embodiment of the present application;

FIG. 2 is a side view of the connector shown in FIG. 1;

FIG. 3 is a cross-sectional view taken along an A-A direction in FIG. 2;

FIG. 4 is a first perspective view of an insulating seat of the connector shown in FIG. 1;

FIG. 5 is a top view of the insulating seat shown in FIG. 4;

FIG. 6 is a second perspective view of the insulating seat of the connector shown in FIG. 1;

FIG. 7 is a first perspective view of a shielding shell of the connector shown in FIG. 1;

FIG. 8 is a second perspective view of the shielding shell shown in FIG. 7;

FIG. 9 is an exploded structural diagram of a connector provided in another embodiment;

FIG. 10 is a perspective view of a conductive terminal of the connector shown in FIG. 9;

FIG. 11 is a schematic structural diagram of a conductive terminal provided in another embodiment;

FIG. 12 is a perspective view of a cover of the connector shown in FIG. 9; and

FIG. 13 is a schematic diagram of a partial structure of the connector shown in FIG. 9, in which the shielding shell is not shown.

### DETAILED DESCRIPTION

In order to make the objectives, technical solutions, and advantages of the embodiments of the present application clearer, the technical solutions in the embodiments of the present application will be described clearly and completely below in conjunction with the accompanying drawings therein. Apparently, the described embodiments are some of the embodiments of the present application, not all of them. Based on the embodiments of the present application, all other embodiments obtained by those of ordinary skill in the art without any creative effort shall fall within the scope of protection of the present application.

The following disclosure provides many different embodiments or examples to implement different structures of the present application. In order to simplify the disclosure of the present application, components and settings in specific examples are described below. Such components and settings are merely examples and are not intended to limit the scope of the present application. In addition, the present application may repeat reference numerals and/or letters in different examples. The repetition is for the purpose of simplification and clarity, and does not indicate the relationship between various discussed embodiments and/or settings.

For ease of description, spatial relative relationship terms can be used herein to describe the relative position or motion of one element or feature shown in the figures relative to the other element or feature. These relative relationship terms include “internal”, “external”, “inner”, “outer”, “below”, “under”, “on”, “above”, “front”, “rear”, etc. The spatial relative relationship terms are intended to include different orientations of an apparatus in use or operation, in addition to the orientations depicted in the figures. For example, if the apparatus in the figures undergoes a position flip, posture change, or motion state change, these directional indications also change accordingly. For example, one element described as “below the other element or feature” or “under the other element or feature” will subsequently be oriented as “on the other element or feature” or “above the other element or feature”. Therefore, the exemplary term “under” may include both upper and lower orientations. The apparatus can be oriented otherwise (rotated 90 degrees or in other directions) and the spatial relative relationship descriptors used herein are explained accordingly.

Hereinafter, some embodiments of the present disclosure will be described in detail with reference to the accompanying drawings. In the case of no conflict, the following embodiments and features in the embodiments can be combined with each other.

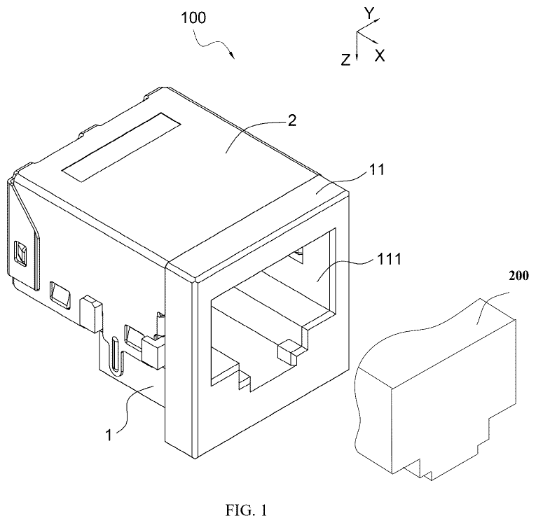

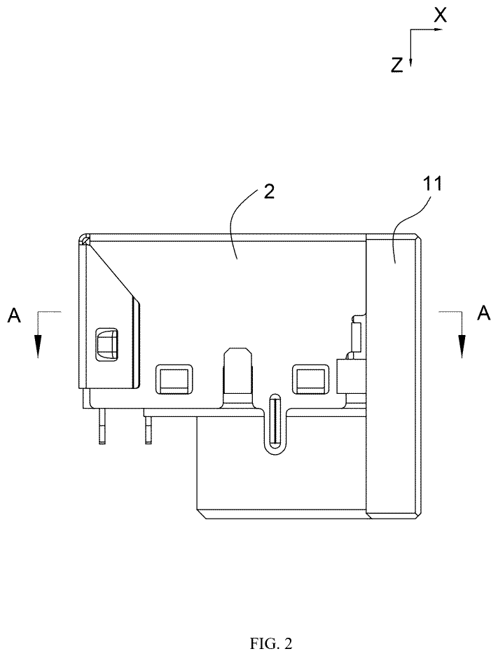

FIG. 1 to FIG. 3 show a connector 100 provided in an embodiment of the present application, including an insulating seat 1 and a shielding shell 2. The insulating seat 1 includes a first end 101 and a second end 102, the first end 101 and the second end 102 are opposite in a first direction, the first end 101 of the insulating seat 1 is connected to an external plug 200, the first end 101 of the insulating seat 1 is provided with a boss 11, the boss 11 is provided with a first opening 111, the first opening 111 is used to dock the external plug 200, the insulating seat 1 is provided with a second opening 12, the second opening 12 is arranged on a side of the boss 11, and the side faces the second end 102 of the insulating seat 1. The shielding shell 2 has a first side 201, and an elastic sheet 24 is provided on the first side 201 of the shielding shell 2. When the shielding shell 2 is sleeved on a peripheral side of the insulating seat 1 along a second direction, the elastic sheet 24 is connected to the second opening 12, and the first side 201 of the shielding shell 2 abuts against the boss 11. The second direction intersects with the first direction.

For the convenience of explanation and understanding, the first direction may be the X direction shown in the figures, the second direction may be the Z direction shown in the figures, two sides of the first direction are front and back respectively, and two sides of the second direction are top and bottom respectively. Understandably, during assembly, the shielding shell 2 is sleeved on the peripheral side of the insulating seat 1 from top to bottom along the second direction, and the elastic sheet 24 is inserted into the interior of the insulating seat 1 from the top of the second opening 12 to the bottom. After installation in place, the elastic sheet 24 is inserted into the second opening 12, so that the first side 201 of the shielding shell 2 abuts against the boss 11 of the insulating seat 1. After the external plug is inserted into the first opening 111 of the boss 11 from the first end 101 of the insulating seat 1 to the second end 102 of the insulating seat 1, the elastic sheet 24 deforms under the squeezing force of the external plug, so that the elastic sheet 24 provides a frictional force to the outer wall of the external plug to prevent the external plug from falling off, thereby improving the stability of connection between the external plug and the connector 100. Since the external plug is separated by the boss 11, the external plug will not directly contact the first side 201 of the shielding shell 2. Even if the insertion force is excessive during connection or the external plug is subjected to external force after connection, the first side 201 of the shielding shell 2 will not be bent outward due to the squeezing force of the external plug, thereby improving the connection stability of the shielding shell 2, preventing external interference signals from entering the interior of the connector 100, enhancing the shielding performance of the connector 100, and further ensuring the normal operation of an electrical appliance.

It should be noted that the insulating seat 1 may be made of a material with a good insulating property such as plastic, and the shielding shell 2 may be made of a metal material with a shielding effect.

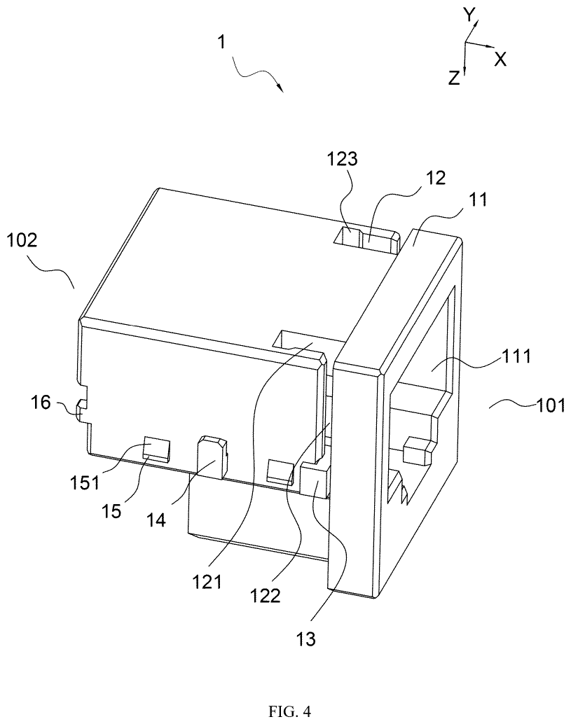

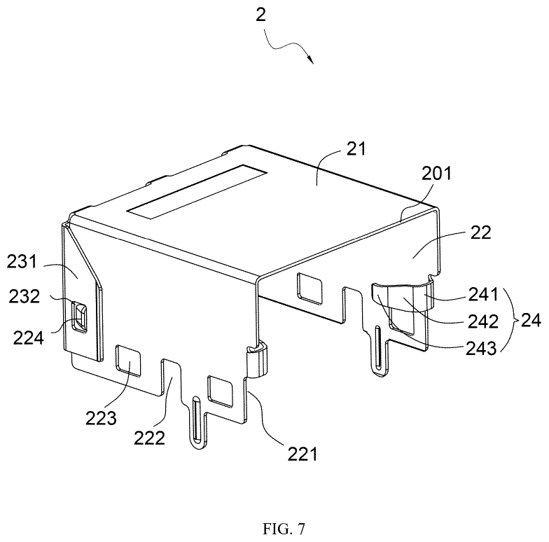

In some embodiments, as shown in FIG. 4 and FIG. 7, the second opening 12 includes a first avoidance groove 121 and a second avoidance groove 122 that are connected, the first avoidance groove 121 extends in the first direction, and the second avoidance groove 122 extends in the second direction, so that the second opening 12 is L-shaped; the shielding shell 2 includes a first baffle 21 and a second baffle 22 that are connected, the first baffle 21 covers the first avoidance groove 121, the second baffle 22 covers the second avoidance groove 122, the elastic sheet 24 is arranged at an end of the second baffle 22, and the end is near the boss 11. By designing the first avoidance groove 121, in the assembly process of the shielding shell 2, the elastic sheet 24 passes through the first avoidance groove 121 from top to bottom, and then continues to move downward along the second avoidance groove 122 until the shielding shell 2 is installed in place with the insulating seat 1. Both the first avoidance groove 121 and the second avoidance groove 122 play a guiding and positioning role.

In some embodiments, as shown in FIG. 7, the elastic sheet 24 includes a connecting portion 241, a wedge-shaped portion 242, and a cantilever portion 243. The connecting portion 241 is connected to the shielding shell 2; two ends of the wedge-shaped portion 242 are connected to the connecting portion 241 and the cantilever portion 243 respectively, and there is an angle between the wedge-shaped portion 242 and a vertical plane (i.e., the plane where the first direction is located); and the cantilever portion 243 is suspended and bent in a direction away from the first opening 111. The wedge-shaped portion 242 enables the elastic sheet 24 to have certain elastic force, that is, the elastic sheet 24 can recover to its initial state after deformation under force, and at the same time, the wedge-shaped portion can increase the structural strength of the elastic sheet 24. The angle is designed as an acute angle. Specifically, the angle may be 15°, 20°, 25°, 30°, 35°, 40°, 45°, etc. Further, the smooth transition connection between the cantilever portion 243 and the wedge-shaped portion 242 prevents stress concentration and brittle fracture at the connection between the cantilever portion 243 and the wedge-shaped portion 242, thereby increasing the overall structural strength of the elastic sheet 24. Since the cantilever portion 243 is suspended, when the external plug is inserted into the first opening 111 of the boss 11 from the first end 101 of the insulating seat 1 to the second end 102 of the insulating seat 1, the bend of the cantilever portion 243 abuts against the outer wall of the external plug, the cantilever portion 243 deforms under the squeezing force of the external plug until the cantilever portion 243 abuts against the inner wall of the insulating seat 1, then the cantilever portion 243 is subjected to a squeezing force from the insulating seat 1, and the bend of the cantilever portion 243 applies a reverse force to the external plug, whereby a frictional force is provided to prevent the external plug from falling off, thereby improving the stability of connection between the external plug and the connector 100.

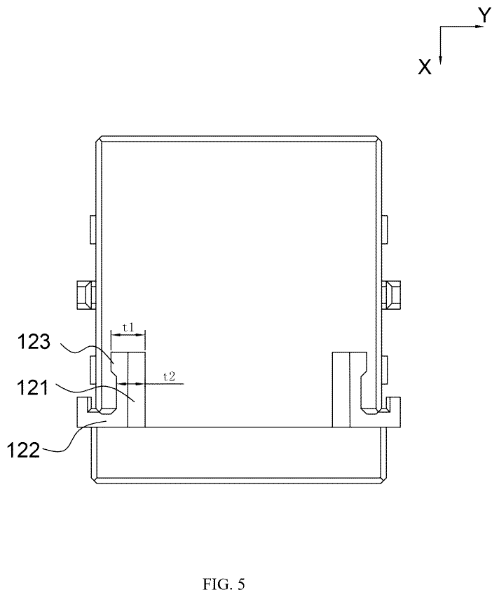

In some embodiments, as shown in FIG. 4 and FIG. 5, a first limit groove 123 is provided on the inner wall of the insulating seat 1, the first limit groove 123 is in communication with the first avoidance groove 121, the first limit groove 123 has a first width t1 in a third direction, the first avoidance groove 121 has a second width t2 in the third direction, t1>t2, and the first limit groove 123 is used to accommodate the cantilever portion 243. The third direction intersects with the first direction.

For the convenience of explanation and understanding, the third direction may be the Y direction shown in the figures. Since the first width of the first limit groove 123 is greater than the second width of the first avoidance groove 121, when the external plug is inserted into the first opening 111 of the boss 11 from the first end 101 of the insulating seat 1 to the second end 102 of the insulating seat 1, the cantilever portion 243 deforms under the squeezing force of the external plug until the cantilever portion 243 abuts against the inner wall of the insulating seat 1 through the first limit groove 123, then the cantilever portion 243 is subjected to a squeezing force from the insulating seat 1, and the bend of the cantilever portion 243 applies a reverse force to the external plug, whereby a frictional force is provided to the external plug. When the external plug is subjected to an external force in the first direction, the first limit groove 123 can provide a reverse stopping force to the cantilever portion 243, thereby preventing the external plug from falling off and further improving the stability of connection between the external plug and the connector 100.

In some embodiments, as shown in FIG. 4 and FIG. 7, the first end 101 of the insulating seat 1 is provided with a first stop platform 13, the first stop platform 13 is arranged at an end of the second avoidance groove 122, the end is away from the first avoidance groove 121, the second baffle 22 is provided with a first notch 221, and the first notch is snap-fitted to the first stop platform 13. In the assembly process of the shielding shell 2, the elastic sheet 24 passes through the first avoidance groove 121 from top to bottom, and then continues to move downward along the second avoidance groove 122. The first stop platform 13 can prevent the shielding shell 2 from excessively moving downward in the second direction and warping, and the first notch 221 is snap-fitted to the first stop platform 13 to stop the shielding shell 2 from moving in the first direction.

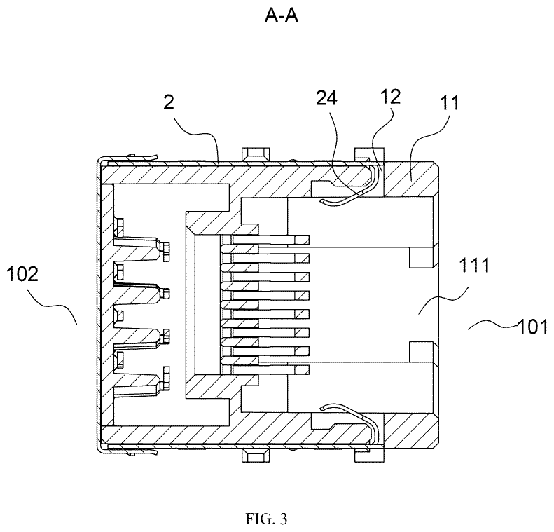

Further, as shown in FIG. 3 and FIG. 4, the orthographic projection of the elastic sheet 24 on a horizontal plane (a plane formed by the X direction and the Y direction) partially covers the orthographic projection of the first stop platform 13 on the horizontal plane, and an end, away from the boss 11, of the first stop platform 13 extends in the first direction until abutting against the outer wall of the second baffle 22. When the shielding shell 2 is sleeved on the peripheral side of the insulating seat 1 in the second direction from top to bottom, the elastic sheet 24 passes through the second opening 12 from top to bottom, and the orthographic projection of the elastic sheet 24 on the horizontal plane partially covers the orthographic projection of the first stop platform 13 on the horizontal plane, so the first stop platform 13 can prevent the elastic sheet 24 from excessively moving downward to play a positioning role, and the first stop platform 13 is snap-fitted to the outer wall of the second baffle 22 to prevent the second baffle 22 from warping outward due to external force, thereby improving the connection stability of the shielding shell 2, preventing external interference signals from entering the interior of the connector 100, and improving the shielding performance of the connector 100.

In some embodiments, as shown in FIG. 4 and FIG. 7, a second stop platform 14 is provided in the middle of the insulating seat 1, the second baffle 22 is provided with a second notch 222, and the second notch is snap-fitted to the second stop platform 14. In the assembly process of the shielding shell 2 and the insulating seat 1, the shielding shell 2 is sleeved on the peripheral side of the insulating seat 1 from top to bottom, and the second stop platform 14 is snap-fitted to the second notch 222 to play a stopping role, thereby limiting the second baffle 22 of the shielding shell 2 from excessively moving downward.

Further, one end of the second stop platform 14 extends in the second direction until abutting against the outer wall of the second baffle 22. After the shielding shell 2 and the insulating seat 1 are assembled, the second stop platform 14 can prevent the shielding shell 2 from excessively moving downward in the second direction or warping due to external forces, thereby improving the connection stability of the shielding shell 2.

In some embodiments, two elastic sheets 24 are designed, the two elastic sheets 24 are arranged opposite in the third direction, two second openings 12 are designed, and the second openings 12 correspond one to one with the two elastic sheets 24. By designing the two elastic sheets 24, after the external plug 200 is inserted into the first opening 111 of the boss 11 from the first end 101 of the insulating seat 1 to the second end 102 of the insulating seat 1, the two elastic sheets 24 deform under the squeezing force of the external plug, so that the cantilever portions 243 of the elastic sheets 24 apply a reverse force to the external plug, thereby providing a frictional force to the external plug to prevent the external plug from falling off, and further improving the stability of connection between the external plug and the connector 100.

Two second baffles 22 may alternatively be designed, the two second baffles 22 are arranged opposite in the third direction, and the two second baffles are wrapped around the peripheral side of the insulating seat 1.

In some embodiments, as shown in FIG. 4 and FIG. 7, the second baffle 22 is provided with a first clamping groove 223, the insulating seat 1 is provided with a first buckle 15, and the first buckle is connected to the first clamping groove 223. After the shielding shell 2 is sleeved on the peripheral side of the insulating seat 1 from top to bottom, the first buckle 15 is snap-fitted to the first clamping groove 223, so that the shielding shell 2 is fixed to the peripheral side of the insulating seat 1. The first clamping groove 223 may be square, circular, trapezoidal, etc., and the cross-section of the first buckle 15 is correspondingly square, circular, trapezoidal, etc. The embodiments of the present application do not limit the shapes.

As shown in FIG. 4, the first buckle 15 may be provided with a guide slope 151. When the shielding shell 2 is sleeved on the peripheral side of the insulating seat 1 from top to bottom, the guide slope 151 plays a guiding role, facilitating assembly and disassembly.

This embodiment may be combined with the previous embodiments to obtain more embodiments. In a preferred embodiment, two first clamping grooves 223 may be designed, two first buckles 15 may be designed in one-to-one correspondence with the first clamping grooves 223, and the two first clamping grooves 223 are arranged on two sides of the second stop platform 14 respectively, thereby enhancing the force uniformity of the shielding shell 2 and improving the stability of connection between the shielding shell 2 and the insulating seat 1.

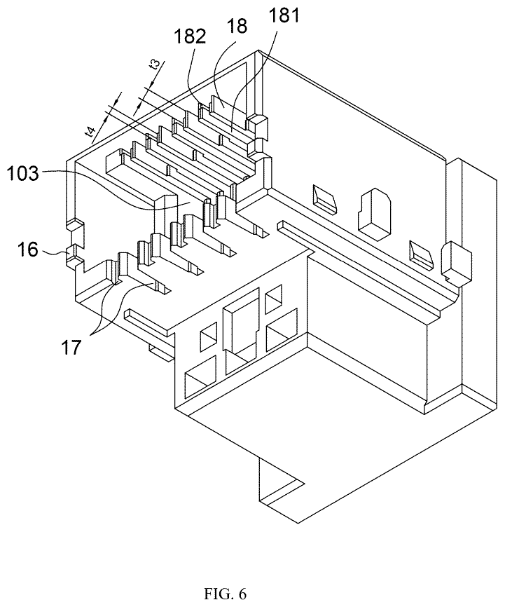

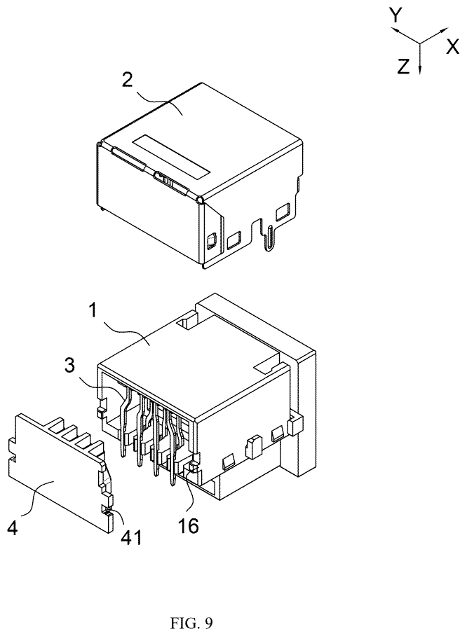

In some embodiments, as shown in FIG. 6 and FIG. 9, the connector 100 includes a conductive terminal 3, the insulating seat 1 is provided with an accommodating chamber 103, the accommodating chamber is in communication with the first opening 111, the conductive terminal 3 is arranged in the accommodating chamber 103 of the insulating seat 1, the second end 102 of the insulating seat 1 is provided with a cover 4, and the cover is used to fix the conductive terminal 3. In this embodiment, the assembly process of the connector 100 is as follows: firstly, the conductive terminal 3 is installed in the accommodating chamber 103 of the insulating seat 1, then the cover 4 is pushed forward from the back to the second end 102 of the insulating seat 1 to fix the conductive terminal 3, and finally, the shielding shell 2 is sleeved on the peripheral side of the insulating seat 1 from top to bottom.

As shown in FIG. 9, first grooves 41 are provided on two sides of the cover 4 respectively, two first lugs 16 are provided at the second end 102 of the insulating seat 1, the two first lugs 16 correspond one to one with the two first grooves 41, and the lugs 16 at the corresponding positions are snap-fitted to the first grooves 41. The interference fit between the first lugs 16 and the first grooves 41 enables the insulating seat 1 to provide friction to the first lugs 16 of the cover 4, and the cover 4 is fixed to the second end 102 of the insulating seat 1, so as to fix the conductive terminal 3.

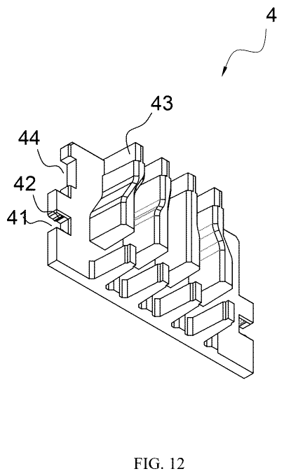

Further, as shown in FIG. 12, raised ribs 42 are provided on the inner wall of the first groove 41, and the raised ribs abut against the first lug 16. The cover 4 is pushed forward from the back to the second end 102 of the insulating seat 1, so that the lugs 16 are snap-fitted to the first grooves 41. Meanwhile, the raised ribs 42 can press against the first lugs 16 to prevent the cover 4 from falling off the insulating seat 1, thereby further improving the connection stability of the cover 4.

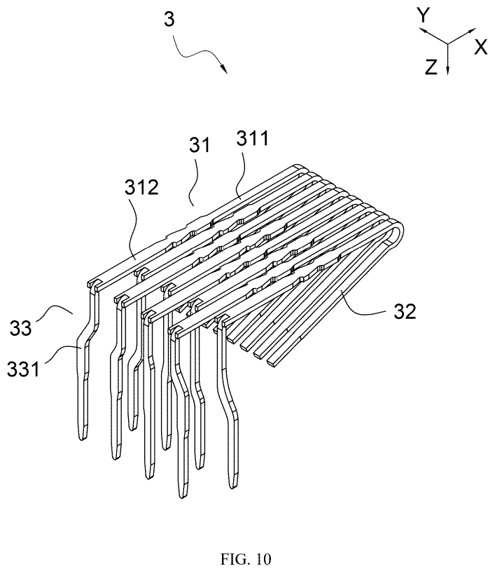

In some embodiments, as shown in FIG. 10, the conductive terminal 3 includes a fixing portion 31, a contact portion 32, and a welding portion 33. The contact portion 32 is bent from one end of the fixing portion 31, and the welding portion 33 is bent and extends upward from the other end of the fixing portion 31; the welding portion 33 includes a plurality of welding pins 331, the two adjacent welding pins 331 are staggered front and back in the first direction, and the spacing between the two adjacent welding pins 331 increases in a direction away from the fixing portion 31. When the conductive terminal 3 is assembled, the spacing can prevent the adjacent welding pins 331 from interfering with each other, making it easier to connect the welding pins 331 to the insulating seat 1 and improving assembly convenience.

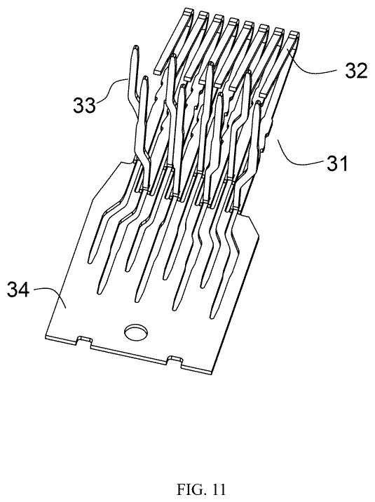

In some embodiments, as shown in FIG. 11, the conductive terminal 3 may further include a bridge 34, and the bridge 34 is arranged at the connection between the fixing portion 31 and the welding portion 33. In the production process of the conductive terminal 3, the bridge 34 may be punched by using a stamping process to form the plurality of welding pins 331 of the welding portion 33 in a single operation. In the assembly process of the connector 100, the bridge 34 may be clamped with an external fixture to push the conductive terminal 3 into the accommodating chamber 103 of the insulating seat 1, facilitating automatic production. After the conductive terminal 3 is installed in place, the bridge 34 may be cut off for subsequent installation of the cover 4 and the shielding shell 2.

Further, as shown in FIG. 6, a plurality of second limit grooves 17 are provided at the second end 102 of the insulating seat 1, the two adjacent second limit grooves 17 are staggered front and back in the first direction, and the second limit grooves 17 are connected to the welding pins 331 in one-to-one correspondence. The staggered arrangement of the two adjacent second limit grooves 17 in the first direction can also prevent the adjacent welding pins 331 from interfering with each other when the conductive terminal 3 is assembled, making it easier to connect the welding pins 331 with the second limit grooves 17. The second limit grooves 17 can limit the movement of the welding pins 331 in the third direction, ensuring the connection stability of the conductive terminal 3. Meanwhile, the second limit grooves 17 also play a positioning role, thereby ensuring the conductivity of the connector 100.

Further, as shown in FIG. 12, a plurality of limit plates 43 are provided on a side, facing the insulating seat 1, of the cover 4; the two adjacent limit plates 43 are staggered front and back in the first direction, and the limit plates 43 are connected to the second limit grooves 17 in one-to-one correspondence; and a side, facing the insulating seat 1, of the limit plate 43 abuts against a side, away from the contact portion 32, of the welding pin 331. The limit plates 43 limit the movement of the welding pins 331 in the first direction, ensuring the connection stability of the conductive terminal 3.

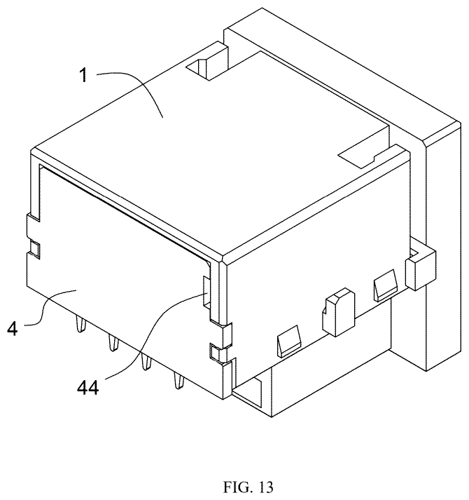

Further, as shown in FIG. 13, the cover 4 is further provided with a through groove 44, and the through groove 44 is spaced apart from the first groove 41, so that an external tool is clamped to the through groove 44 to remove the cover 4.

In some embodiments, as shown in FIG. 6 and FIG. 10, the fixing portion 31 includes a plurality of fixing pins 311, and the fixing pins 311 are connected to the welding pins 331 in one-to-one correspondence; a plurality of partitions 18 are provided inside the insulating seat 1, a limit space 181 is formed between the two adjacent partitions 18, the limit space 181 is used to accommodate the fixing pins 311, an end of the contact portion 32 abuts against the partitions 18, and the end is away from the fixing portion 31. The fixing pins 311 are inserted into the limit spaces 181 to limit the fixing portion 31 and prevent the fixing portion 31 from moving in the second direction. The end, away from the fixing portion 31, of the contact portion 32 abuts against the partitions 18 to play a limiting role, too.

Further, a widened portion 312 is provided at an end of the fixing pin 311, the end is near the welding pin 331, a second groove 182 is provided on a side wall of the partition 18, and the second groove is connected to the widened portion 312. The widened portion 312 can increase the overall structural strength of the conductive terminal 3. The second groove 182 is snap-fitted to the widened portion 312 to prevent the conductive terminal 3 from jamming during installation. The limit space 181 formed between the two adjacent partitions 18 has a third width t3 in the second direction, the two second grooves 182 located in the same limit space 181 have a fourth width t4 in the second direction, and t3<t4. The contact portion 32 is clamped in the limit space 181, and the end, away from the fixing portion 31, of the contact portion 32 abuts against the partitions 18, thereby increasing the clamping force between the contact portion 32 and the limit space 181, which can increase the overall structural strength of the connector 100. When the external plug is docked with the first opening 111 of the insulating seat 1 from front to back, the contact portion 32 is not prone to fracture due to transient external force, so that the connector 100 can pass a transient fracture test.

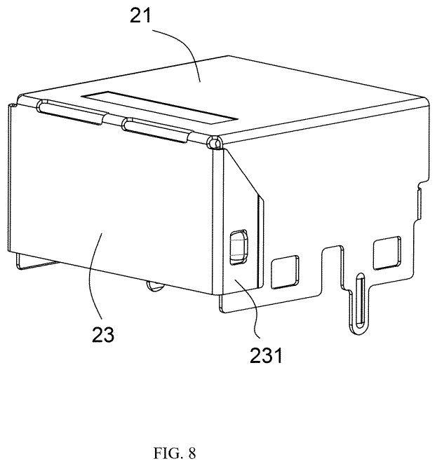

In some embodiments, as shown in FIG. 8, the shielding shell 2 includes a third baffle 23, the third baffle 23 is connected to the first baffle 21, and the third baffle 23 is wrapped around the peripheral side of the cover 4. The third baffle 23 can prevent external interference signals from entering the interior of the connector 100, thereby improving the shielding performance of the connector 100 and ensuring the normal operation of the electrical appliance.

Further, as shown in FIG. 7, extension plates 231 are provided on two sides of the third baffle 23 respectively, the extension plates 231 are bent towards the boss 11 relative to the third baffle 23, the third baffle 23 is provided with a second clamping groove 232, the second baffle 22 is provided with a second buckle 224, and the second buckle is snap-fitted to the second clamping groove 232. The second buckle 224 is snap-fitted to the second clamping groove 232 to improve the stability of connection between the third baffle 23 and the second baffle 22, and to prevent the third baffle 23 from warping due to external force. The second clamping groove 232 may be square, circular, trapezoidal, etc., and the cross-section of the second buckle 224 is correspondingly square, circular, trapezoidal, etc. The embodiments of the present application do not limit the shapes.

It should be understood that the terms used herein are only for the purpose of describing specific exemplary implementations and are not intended to be restrictive. Unless otherwise explicitly stated in the context, singular forms such as “a”, “one”, and “the” used herein may further include plural forms. The terms “comprise”, “include”, “contain”, and “have” are inclusive and therefore indicate the existence of the stated features, steps, operations, elements, and/or components, but do not exclude the existence or addition of one or more other features, steps, operations, elements, components, and/or combinations thereof. The method steps, processes, and operations described herein are not interpreted as requiring them to be executed in a specific order described or illustrated, unless an execution order is clearly indicated. It should also be understood that additional or alternative steps can be used.

Although the terms first, second, third, etc. can be used herein to describe a plurality of elements, components, regions, layers, and/or segments, these elements, components, regions, layers, and/or segments should not be limited by these terms. These terms can only be used for distinguishing one element, component, region, layer, or segment from another. Unless explicitly stated in the context, the terms such as “first” and “second” and other numerical terms used herein do not imply order or sequence. Therefore, the first element, component, region, layer, or segment discussed below may be referred to as the second element, component, region, layer, or segment without departing from the teachings of the example embodiments.

Described above are merely specific implementations of the present application, enabling a person skilled in the art to understand or implement the present application. Various modifications to these embodiments are apparent to the person skilled in the art. General principles defined herein may be implemented in other embodiments without departing from the spirit or scope of the present application. Therefore, the present application will not be limited to these embodiments shown herein, but will conform to the widest scope consistent with the principle and novelty of the present application.

What is claimed is:

1. A connector, comprising:
an insulating seat, wherein the insulating seat comprises a first end and a second end, the first end and the second end are opposite in a first direction, the first end of the insulating seat is connected to an external plug, the first end of the insulating seat is provided with a boss, the boss is provided with a first opening, the first opening is used to connect the external plug, and the insulating seat is provided with a second opening; and
a shielding shell, wherein the shielding shell has a first side, and an elastic sheet is provided on the first side of the shielding shell;
wherein when the shielding shell is sleeved on a peripheral side of the insulating seat along a second direction, the elastic sheet is connected to the second opening, and the first side of the shielding shell abuts against the boss, wherein the second direction intersects with the first direction.

2. The connector according to claim 1, wherein the second opening comprises a first avoidance groove and a second avoidance groove that are connected, the first avoidance groove extends in the first direction, and the second avoidance groove extends in the second direction; and
the shielding shell comprises a first baffle and a second baffle that are connected, the first baffle covers the first avoidance groove, the second baffle covers the second avoidance groove, the elastic sheet is arranged at an end of the second baffle, and the end is near the boss.

3. The connector according to claim 2, wherein the elastic sheet comprises a connecting portion, a wedge-shaped portion, and a cantilever portion, wherein the connecting portion is connected to the shielding shell;
two ends of the wedge-shaped portion are connected to the connecting portion and the cantilever portion respectively, and there is an angle between the wedge-shaped portion and a vertical plane; and
the cantilever portion is suspended and bent in a direction away from the first opening.

4. The connector according to claim 3, wherein a first limit groove is provided on the inner wall of the insulating seat, the first limit groove is in communication with the first avoidance groove, the first limit groove has a first width in a third direction, the first avoidance groove has a second width in the third direction, the first width is greater than the second width, and the first limit groove is used to accommodate the cantilever portion, wherein the third direction intersects with the first direction.

5. The connector according to claim 2, wherein the first end of the insulating seat is provided with a first stop platform, the first stop platform is arranged at an end of the second avoidance groove, the end is away from the first avoidance groove, the second baffle is provided with a first notch, and the first notch is snap-fitted to the first stop platform.

6. The connector according to claim 5, wherein the orthographic projection of the elastic sheet on a horizontal plane partially covers the orthographic projection of the first stop platform on the horizontal plane, and an end, away from the boss, of the first stop platform extends in the first direction until abutting against the outer wall of the second baffle.

7. The connector according to claim 2, wherein a second stop platform is provided in the middle of the insulating seat, the second baffle is provided with a second notch, and the second notch is snap-fitted to the second stop platform.

8. The connector according to claim 7, wherein one end of the second stop platform extends in the second direction until abutting against the outer wall of the second baffle.

9. The connector according to claim 1, wherein two elastic sheets are designed, the two elastic sheets are arranged opposite in the third direction, two second openings are designed, and the second openings correspond one to one with the elastic sheets, wherein the third direction intersects with the first direction.

10. The connector according to claim 2, wherein the second baffle is provided with a first clamping groove, the insulating seat is provided with a first buckle, and the first buckle is connected to the first clamping groove.

11. The connector according to claim 2, further comprising a conductive terminal, wherein the insulating seat is provided with an accommodating chamber, the accommodating chamber is in communication with the first opening, the conductive terminal is arranged in the accommodating chamber of the insulating seat, the second end of the insulating seat is provided with a cover, and the cover is used to fix the conductive terminal.

12. The connector according to claim 11, wherein the cover is provided with a first groove, the second end of the insulating seat is provided with a first lug, and the first lug is connected to the first groove.

13. The connector according to claim 12, wherein a raised rib is provided on the inner wall of the first groove, and the raised rib is connected to the first lug.

14. The connector according to claim 11, wherein the conductive terminal comprises a fixing portion, a contact portion, and a welding portion, wherein the contact portion is formed by bending from one end of the fixing portion, and the welding portion is extended by bending from the other end of the fixing portion; and
the welding portion comprises a plurality of welding pins, the two adjacent welding pins are staggered in the first direction, and the spacing between the two adjacent welding pins increases in a direction away from the fixing portion.

15. The connector according to claim 14, wherein a plurality of second limit grooves are provided at the second end of the insulating seat, the two adjacent second limit grooves are staggered in the first direction, and the second limit grooves are connected to the welding pins in one-to-one correspondence.

16. The connector according to claim 15, wherein a plurality of limit plates are provided on a side, facing the insulating seat, of the cover; the two adjacent limit plates are staggered in the first direction, and the limit plates are connected to the second limit grooves in one-to-one correspondence; and a side, facing the insulating seat, of the limit plate abuts against a side, away from the contact portion, of the welding pin.

17. The connector according to claim 14, wherein the fixing portion comprises a plurality of fixing pins, and the fixing pins are connected to the welding pins in one-to-one correspondence; and
a plurality of partitions are provided inside the insulating seat, a limit space is formed between the two adjacent partitions, the limit space is used to accommodate the fixing pins, an end of the contact portion abuts against the partitions, and the end is away from the fixing portion.

18. The connector according to claim 11, wherein the shielding shell comprises a third baffle, the third baffle is connected to the first baffle, and the third baffle is wrapped around the peripheral side of the cover; and
an extension plate is provided on the third baffle, the extension plate is bent towards the boss relative to the third baffle, the third baffle is provided with a second clamping groove, the second baffle is provided with a second buckle, and the second buckle is connected to the second clamping groove.

19. The connector according to claim 3, further comprising a conductive terminal, wherein the insulating seat is provided with an accommodating chamber, the accommodating chamber is in communication with the first opening, the conductive terminal is arranged in the accommodating chamber of the insulating seat, the second end of the insulating seat is provided with a cover, and the cover is used to fix the conductive terminal.

20. The connector according to claim 5, further comprising a conductive terminal, wherein the insulating seat is provided with an accommodating chamber, the accommodating chamber is in communication with the first opening, the conductive terminal is arranged in the accommodating chamber of the insulating seat, the second end of the insulating seat is provided with a cover, and the cover is used to fix the conductive terminal.
